(19) United States
(12) Patent Application Publication
(10) Pub. No.: US 2012/0154158 A1
(43) Pub. Date: Jun. 21, 2012

(54) COMPUTING DEVICE AND ALARM METHOD OF THE COMPUTING DEVICE

(75) Inventors: YU-GANG ZHANG, Shenzhen City (CN); JIA-QING HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/308,555

(22) Filed: Dec. 1, 2011

(30) Foreign Application Priority Data
Dec. 21, 2010 (CN) 201010599037.2

(51) Int. Cl. G08B 17/00

(52) U.S. Cl. 340/584

(57) ABSTRACT

In an alarm method of a computing device, real-time parameters are obtained from sensors installed in the computing device. If any of the real-time parameters is not within a preset range, an alarm message is generated and tried to send to the remote device via the network interface card. The alarm message is stored in a storage system of the computing device. If the computing device is turned off or powered up during alarm message sending attempts, the alarm message is retrieved from the storage system and retried to send to the remote device via the network interface card.

### BACKGROUND

1. Technical Field

Embodiments of the present disclosure relate to electronic alarm systems and methods, and particularly to a computing device and an alarm method of the computing device.

2. Description of Related Art

A baseboard management controller (BMC) is a specialized microcontroller embedded in a computing device, such as a server. Different types of sensors may be installed in the computing device that detect real-time parameters (e.g., voltages, operating temperatures, and fan speeds) of the computing device. The BMC sends alarm messages to a remote device via a network interface card, if any of the real-time parameters is not within a preset range, indicating a potential failure of the computing device. In some cases, the computing device may be turned off or reset during the process of sending the alarm messages. When the computing device is turned off or powering up, the network interface card go temporarily offline, which may result in a failure to send the alarm messages.

### BRIEF DESCRIPTION OF THE DRAWINGS

FIG. 1 is one embodiment of a computing device including an alarm unit.

FIG. 2 is a block diagram of one embodiment of the alarm unit included in a BMC of the computing device 10 of FIG. 1.

FIG. 3 is a flowchart of one embodiment of an alarm method of a computing device, such as that of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

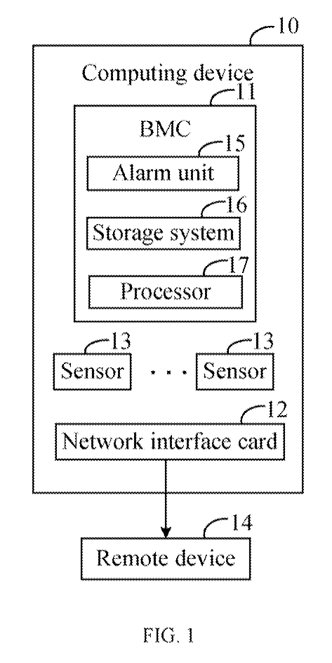

FIG. 1 is one embodiment of a computing device 10 including an alarm unit 15. In one embodiment, the computing device 10 further includes a base motherboard controller (BMC) 11, a network interface card 12, and a plurality of sensors 13. The computing device 10 is connected to a remote device 14 (e.g., a server) via the network interface card 12. The sensors 13 measure real-time parameters of the computing device 10 such as voltages, operating temperatures, and fan speeds. If any of the real-time parameters is not within a preset range, indicating a potential failure of the computing device 10, the BMC 11 sends alarm messages to the remote device 14 via the network interface card 12. The computing device 10 may be a computer or a server, for example.

The alarm unit 15 is included in the BMC 11 that further includes a storage system 16 and at least one processor 17. The alarm unit 15 ensures that the alarm messages are sent to the remote device 14 successfully. In one embodiment, the storage system 16 may be a serial peripheral interface (SPI) flash memory, a random access memory (RAM) for the temporary storage of information, and/or a read only memory (ROM) for the permanent storage of information.

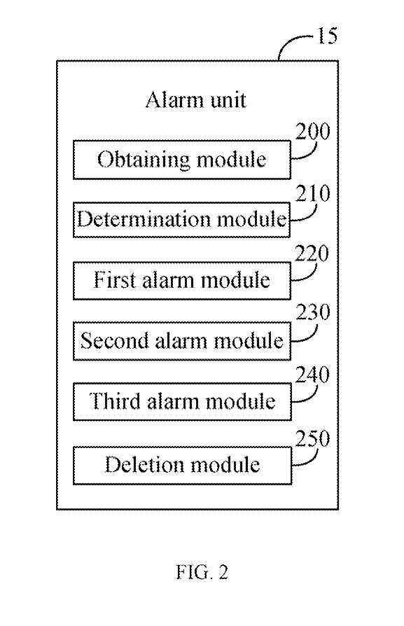

FIG. 2 is a block diagram of one embodiment of the alarm unit 15 included in the BMC 11 of the computing device 10 of FIG. 1. In one embodiment, the alarm unit 15 may include an obtaining module 200, a determination module 210, a first alarm module 220, a second alarm module 230, a third alarm module 240, and a deletion module 250. The function modules 200-250 may comprise computerized codes in the form of one or more programs that are stored in the storage system 16. The computerized codes includes instructions that are executed by the at least one processor 17 to provide functions for the modules. In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of non-transitory computer-readable medium or other storage device.

The obtaining module 200 obtains the real-time parameters of the computing device 10 from the sensors 13. In one embodiment, the real-time parameters may include individual voltages, operating temperatures, and/or fan speeds of critical components, such as a motherboard, a CPU, a graphics processing unit, and hard disk drive(s), included in the computing device 10. The obtaining module 200 may obtain the real-time parameters at a predetermined frequency, such as every 30 seconds.

The determination module 210 determines whether any of the real-time parameters is not within a preset range. For example, if a preset range for the operating temperature of the CPU is less than 85 degrees Celsius and a real-time operating temperature of the CPU is 86 degrees Celsius, the real-time operating temperature of the CPU is not within the corresponding preset range.

The first alarm module 220 generates an alarm message and makes a first attempt to send the alarm message to the remote device 14 via the network interface card 12, if at least one of the real-time parameters is not within the preset range. Meanwhile, the first alarm module 220 stores the alarm message in the storage system 16. In one embodiment, the first alarm module 220 may store the alarm message in the SPI flash memory of the storage system 16.

The second alarm module 230 detects whether the computing device 10 is turned off during the first attempt by the first alarm module 220 to send the alarm message. If the computing device 10 is turned off during the first attempt to send the alarm message, the second alarm module 230 retrieves the alarm message from the storage system 16 and makes a second attempt to send the alarm message to the remote device 14 via the network interface card 12. In one embodiment, because the network interface card 12 may go temporarily offline during the process of the computing device 10 powering down, the second alarm module 230 waits a first time interval (e.g., 30 seconds) after detection of the computing device 10 shutdown before making the second attempt to send the alarm message to the remote device 14 to allow time for the network interface card 12 to go back online.

The third alarm module 240 detects whether the computing device 10 is powered up during the second attempt by the second alarm module 230 to send the alarm message. If the computing device 10 is turned on and powered up during the second attempt to send alarm message, the network interface card 12 may again go temporarily offline, and so the third alarm module 240 retrieves the alarm message from the storage system 16 and makes a third attempt to send the alarm message to the remote device 14 via the network interface card 12 after a second time interval (e.g., 60 seconds).

The second alarm module 230 further detects whether the computing device 10 is turned off during the third attempt by the third alarm module 240 to send the alarm message. If the computing device 10 is turned off during the third attempt to send the alarm message, the second alarm module 230 again retrieves the alarm message from the storage system 16 and makes a second attempt to send the alarm message to the remote device 14 via the network interface card 12 after the first time interval.

The deletion module 250 deletes the alarm message from the storage system 16 if the second alarm module 220 does not detect that the computing device 10 is turned off or the third alarm module 230 does not detect that the computing device 10 is powered up during alarm message sending attempts.

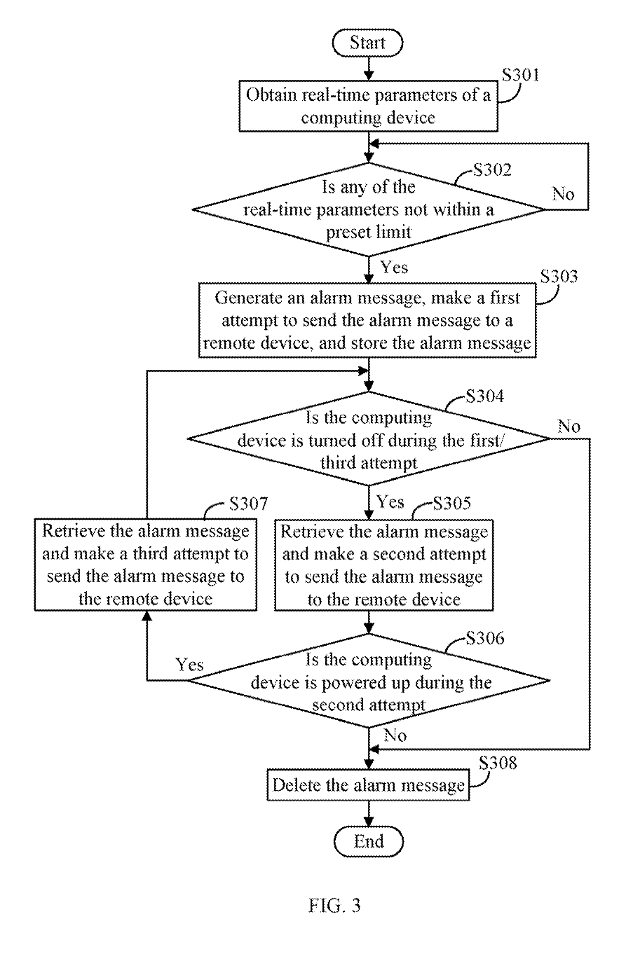

FIG. 3 is a flowchart of one embodiment of an alarm method of a computing device, such as that of FIG. 1. Depending on the embodiments, additional blocks may be added, others removed, and the ordering of the blocks may be changed.

In block S301, the obtaining module 200 obtains real-time parameters of the computing device 10 from the sensors 13. As mentioned above, the real-time parameters may include individual voltages, operating temperatures, and/or fan speeds of motherboard, CPU, graphics processing unit, and hard disk drive(s) included in the computing device 10.

In block S302, the determination module 210 determines whether any of the real-time parameters is not within a preset range. For example, if a preset range for the operating temperature of the CPU is less than 85 degrees Celsius and a real-time operating temperature of the CPU is 86 degrees Celsius, the real-time operating temperature of the CPU is not within the corresponding preset range.

If one or more of the real-time parameters are not within preset ranges, in block S303, the first alarm module 220 generates an alarm message, makes a first attempt to send the alarm message to the remote device 14 via the network interface card 12, and stores the alarm message in the storage system 16.

In block S304, the second alarm module 230 detects whether the computing device 10 is turned off during the first attempt by the first alarm module 220 to send the alarm message. In one embodiment, the computing device 10 may generate a power off signal when the computing device 10 is turned off. The second alarm module 230 detects the computing device 10 turned off upon receiving the power off signal.

If detecting that the computing device 10 is turned off during the first attempt to send the alarm message, in block S305, the second alarm module 230 retrieves the alarm message from the storage system 16 and makes a second attempt to send the alarm message to the remote device 14 via the network interface card 12. In one embodiment, the second alarm module 230 waits a first time interval (e.g., 30 seconds) after detection of the computing device 10 shutdown before making the second attempt to send the alarm message to the remote device 14. If the second alarm module 230 does not detect that the computing device 10 is turned off during the first attempt to send the alarm message, indicating the alarm message has been sent to the remote device 14 successfully, the process goes to block S308.

In block S306, the third alarm module 240 detects whether the computing device 10 is powered up during the second attempt by the second alarm module 230 to send the alarm message. In one embodiment, the computing device 10 may generate a power on signal when the computing device 10 is powered up. Upon receiving the power on signal, the third alarm module 240 detects that the computing device 10 is powered up.

If detecting that the computing device 10 is powered up during the second attempt by the second alarm module 230 to send the alarm message, in block S307, the third alarm module 240 retrieves the alarm message from the storage system 16 and makes a third attempt to send the alarm message to the remote device 14 via the network interface card 12. The process then returns to block S304, wherein the second alarm module 230 detects whether the computing device 10 is turned off during the third attempt by the third alarm module 240 to send the alarm message. In one embodiment, the third alarm module 240 makes the third attempt to send the alarm message to the remote device 14 via the network interface card 12 after a second time interval (e.g., 60 seconds). If the third alarm module 240 does not detect the computing device 10 is powered up during the second attempt by the second alarm module 230 to send the alarm message, indicating the alarm message has been sent to the remote device 14 successfully, the process goes to block S308.

In block S308, the deletion module 250 deletes the alarm message from the storage system 16 if the second alarm module 220 does not detect that the computing device 10 is turned off or the third alarm module 230 does not detect that the computing device 10 is powered up during alarm message sending attempts.

All of the processes described above may be embodied in, and fully automated via, functional code modules executed by one or more general purpose processors of the electronic devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a network interface card;
one or more sensors that measures real-time parameters of the computing device; and
a base motherboard controller (BMC), the BMC comprising:
a storage system;
at least one processor, and
an alarm unit comprising one or more computerized codes, which are stored in the storage system and executed by the at least one processor, the one or more computerized codes comprising:
an obtaining module operable to obtain the real-time parameters from the one or more sensors;
a determination module operable to determine whether any of the real-time parameters is not within a preset range;
a first alarm module operable to generate an alarm message, make a first attempt to send the alarm message to a remote device via the network interface card, and store the alarm message in the storage system, upon condition that at least one of the real-time parameters is not within the preset range;
a second alarm module operable to retrieve the alarm message from the storage system and make a second attempt to send the alarm message to the remote device via the network interface card after a first time interval, upon condition that the computing device is turned off during the first attempt to send the alarm message; and
a third alarm module operable to retrieve the alarm message from the storage system and make a third attempt to send the alarm message to the remote device via the network interface card after a second time interval, upon condition that the computing device is powered up during the second attempt to send the alarm message;
the second alarm module further operable to retrieve the alarm message from the storage system and make the second attempt to send the alarm message to the remote device via the network interface card after the first time interval, upon condition that the computing device is turned off during the third attempt to send the alarm message.

2. The computing device of claim 1, wherein the one or more computerized codes further comprises a deletion module operable to delete the alarm message from the storage system.

3. The system of claim 1, wherein the real-time parameters comprise individual voltages, operating temperatures, and/or fan speeds of critical components included in the computing device.

4. The system of claim 1, wherein the alarm message is stored in a serial peripheral interface (SPI) flash memory of the storage system.

5. An alarm method of a computing device, the computing device connected to a remote device via a network interface card included in the computing device, the method comprising:
obtaining real-time parameters from one or more sensors installed in the computing device;
determining whether any of the real-time parameters is not within a preset range;
generating an alarm message according to the real-time parameters, making a first attempt to send the alarm message to the remote device via the network interface card, and storing the alarm message in a storage system of the computing device, upon condition that at least one of the real-time parameters is not within the preset range;
detecting whether the computing device is turned off during the first attempt to send the alarm message;
retrieving the alarm message from the storage system and making a second attempt to send the alarm message to the remote device via the network interface card after a first time interval, upon condition that the computing device is turned off during the first attempt to send the alarm message;
detecting whether the computing device is powered up during the second attempt to send the alarm message; and
retrieving the alarm message from the storage system and making a third attempt to send the alarm message to the remote device via the network interface card after a second time interval, upon condition that the computing device is powered up during the second attempt to send the alarm message.

6. The method of claim 5, further comprising:
deleting the alarm message from the storage system.

7. The method of claim 5, wherein the real-time parameters comprise individual voltages, operating temperatures, and/or fan speeds of critical components included in the computing device.

8. The method of claim 5, wherein the alarm message is stored in a serial peripheral interface (SPI) flash memory of the storage system.

9. A non-transitory storage medium having stored thereon instructions that, when executed by a processor of a computing device, causes the computing device to execute an alarm method, the computing device connected to a remote device via a network interface card included in the computing device, the method comprising:
obtaining real-time parameters from one or more sensors installed in the computing device;
determining whether any of the real-time parameters is not within a preset range;
generating an alarm message according to the real-time parameters, making a first attempt to send the alarm message to the remote device via the network interface card, and storing the alarm message in a storage system of the computing device, upon condition that at least one of the real-time parameters is not within the preset range;
detecting whether the computing device is turned off during the first attempt to send the alarm message;
retrieving the alarm message from the storage system and making a second attempt to send the alarm message to the remote device via the network interface card after a first time interval, upon condition that the computing device is turned off during the first attempt to send the alarm message;
detecting whether the computing device is powered up during the second attempt to send the alarm message; and
retrieving the alarm message from the storage system and making a third attempt to send the alarm message to the remote device via the network interface card after a second time interval, upon condition that the computing device is powered up during the second attempt to send the alarm message.

10. The storage medium of claim 9, wherein the method further comprises:
deleting the alarm message from the storage system.

11. The storage medium of claim 9, wherein the real-time parameters comprise individual voltages, operating temperatures, and/or fan speeds of critical components included in the computing device.

12. The storage medium of claim 9, wherein the alarm message is stored in a serial peripheral interface (SPI) flash memory of the storage system.
